(19) United States
(12) Patent Application Publication
(10) Pub. No.: US 2024/0209247 A1
(43) Pub. Date: Jun. 27, 2024

(54) GREEN ALTERNATIVE POLYURETHANE ADHESIVE

(71) Applicant: Henkel AG & Co. KGaA, Duesseldorf (DE)

(72) Inventors: Mary E. Palliardi, Andover, CT (US); Chih-Min Cheng, Westford, MA (US)

(21) Appl. No.: 18/557,818

(22) PCT Filed: Apr. 19, 2022
(86) PCT No.: PCT/US2022/025264

§ 371 Date: Oct. 27, 2023

Related U.S. Application Data
(60) Provisional application No. 63/186,352, filed on May 10, 2021.

(51) Int. Cl. C09J 175/06; B01D 63/10; B01D 69/12; B01D 71/56; B01D 71/68; B32B 7/12; B32B 27/08; B32B 27/28; B32B 27/34; C08G 18/10; C08G 18/32; C08G 18/36; C08G 18/79; C09J 7/26; C09J 7/29; C09J 7/38

(52) U.S. Cl. CPC C09J 175/06; B01D 63/10; B01D 69/12; B01D 71/56; B01D 71/68; B32B 7/12; B32B 27/08; B32B 27/286; B32B 27/34; C08G 18/10; C08G 18/3206; C08G 18/36; C08G 18/797; C09J 7/26; C09J 7/29; C09J 7/38; B01D 2313/143; C08G 2340/00; C09J 2477/006; C09J 2481/006

(57) ABSTRACT

Disclosed is a two-component, liquid curable polyurethane adhesive system comprising an isocyanate reactive part A and an isocyanate functional part B. Either or both parts include substantial amounts of sustainable materials. The inventive mixed adhesive compositions are able to effectively bond to a separation membrane of a filtration apparatus. The invention is also directed to a method of bonding filter assembly components using this two-component curable polyurethane adhesive composition and a filter assembly bonded together using this adhesive composition.

### FIELD OF THE INVENTION

This disclosure relates generally to a two-component, liquid curable polyurethane adhesive system comprising an isocyanate reactive part A and an isocyanate functional part B. The isocyanate functional part B comprises one or more isocyanate functional materials. The isocyanate reactive part A comprises an isocyanate reactive mixture. Either or both parts include substantial amounts of sustainable materials. These two parts are mixed just before use to form a polyurethane adhesive composition and react together (“cure”) to an irreversible solid polymer form. The inventive mixed adhesive compositions are able to effectively penetrate and bond to a separation membrane of a filtration apparatus. The invention is also directed to a method of bonding filter assembly components using this two-component curable polyurethane adhesive composition and a filter assembly bonded together using this adhesive composition.

### BACKGROUND OF THE INVENTION

Membrane filters use polyurethane adhesives to bond components therein, such as the membrane sheets to themselves, the membrane sheets to a permeate tube and the wound filter assembly to an endcap.

It is known to use two-component adhesives to bond membrane filter components. A two component (2K) composition has two or more parts, typically an isocyanate reactive part A and an isocyanate functional part B. Each of the parts is prepared, warehoused and shipped separately from the other parts. The parts are mixed immediately prior to use. Mixing of the parts starts a cure reaction so commercial storage after mixing is not possible.

However, many conventional adhesives will not work acceptably in a membrane filter bonding application. Some mixed adhesives have a low viscosity and will unacceptably spread or run on a membrane surface. Some mixed adhesives have a high viscosity and are difficult to dispense and work in this application. Some mixed adhesives will not penetrate into the membrane material, leading to weak bonds and potential lifting away from the membrane surface (blistering) during use. “Blistering” is generally understood to mean a failure of a bonded membrane portion, usually due to the incursion of water between the bonded layers. Some cured adhesives unacceptably dissolve or breakdown when exposed to the very high or low pH environments common to membrane filter use. Naturally, the cured adhesive must have adequate strength to maintain the bonded components under high pressures in liquid environments. For food filtration applications it is highly desirable to use adhesives and materials that are compatible with food contact. The adhesive must have a sufficiently long enough open time to allow assembly of the components but a short enough cure time to provide the assembled membrane filter with sufficient strength to quickly allow movement to the next manufacturing operation.

Each application method will require the newly mixed adhesive to be within a defined viscosity range for successful use; below this range the applied mixture will spread and run and above this range the mixed adhesive may not apply evenly or at all. Viscosity of the newly mixed adhesive will be a composite of the viscosity of each part. Two-component curable polyurethane systems have traditionally used silicas or amines in the isocyanate reactive part as rheology modifiers to thicken the isocyanate reactive part and thereby increase the viscosity or “thicken” mixtures of the mixed adhesive.

Polyurethane adhesives used to bond membrane filter components have previously been limited to those comprising materials sourced completely or substantially from petrochemical feedstocks or other non-renewable sources. There is a strong and growing interest in using materials made from renewable or sustainable resources to replace their conventional non-renewable counterparts. It is even more desirable to use materials made from renewable or sustainable resources that are not part of the food chain. Naturally, the sustainable adhesives must also meet all of the other demanding requirements in a membrane bonding application.

### SUMMARY OF THE INVENTION

One aspect of the disclosure provides a two-component, liquid curable polyurethane adhesive system comprising an isocyanate functional part B and an isocyanate reactive part A. The isocyanate functional part B comprises an isocyanate functional material or mixture. The isocyanate reactive part A comprises an isocyanate reactive mixture. Either or both parts include substantial amounts of sustainable materials.

Another aspect of the disclosure provides an isocyanate reactive part A comprised of 80% sustainable materials, preferably 90% sustainable materials and more preferably about 100% sustainable materials, in each case based on the weight of the isocyanate reactive part.

Another aspect of the disclosure provides an isocyanate reactive part A comprising a sustainable reactive rheology modifier, preferably from a non-food source.

Another aspect of the disclosure provides a method of bonding filter assembly parts using a mixed two-component curable polyurethane system substantially comprised of sustainable materials.

Another aspect of the disclosure provides a filter assembly bonded together using a mixed two-component curable polyurethane system substantially comprised of sustainable materials.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

### BRIEF DESCRIPTION OF THE FIGURES

FIG. 1 shows a schematic cross section of a typical filter membrane;

FIG. 2 shows a schematic representation of a spiral-wound membrane element in use;

FIG. 3 shows a step in the construction of a membrane leaf element; and

FIG. 4 shows another step in the construction of a spiral-wound membrane element.

FIG. 5 is a series of pictures showing membrane penetration of different mixed adhesives.

### DETAILED DESCRIPTION OF THE INVENTION

Unless defined otherwise, all technical and scientific terms used herein have the same meaning as is commonly understood by one of ordinary skill in the art. As used herein for each of the various embodiments, the following definitions apply.

The singular forms “a”, “an” and “the” include plural referents unless the context clearly dictates otherwise.

About or “approximately” as used herein in connection with a numerical value refer to the numerical value±10%, preferably +5% and more preferably +1% or less.

At least one, as used herein, means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

The terms “comprising”, “comprises” and “comprised of” as used herein are synonymous with “including”, “includes”, “containing” or “contains”, and are inclusive or open-ended and do not exclude additional, non-recited members, elements or method steps.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

“Amine” refers to a molecule comprising at least one —NHR group wherein R can be a covalent bond, H, hydrocarbyl or polyether. In some embodiments an amine can comprise a plurality of —NHR groups (which may be referred to as a polyamine).

The term “Free of”, as used in this context, means that the amount of the corresponding substance in the reaction mixture is less than 0.05 wt. %, preferably less than 0.01 wt. %, more preferably less than 0.001 wt. %, based on the total weight of the reaction mixture.

“Hydrocarbyl” refers to a group containing carbon and hydrogen atoms. The hydrocarbyl can be linear, branched, or cyclic group. The hydrocarbyl can be alkyl, alkenyl, alkynyl or aryl. In some embodiments, the hydrocarbyl is substituted.

Isocyanate or NCO content refers to the NCO content as determined according to EN ISO 11909.

“Molecular weight” refers to number average molecular weight unless otherwise specified. The number average molecular weight Mn, as well as the weight average molecular weight Mw, is determined according to the present invention by gel permeation chromatography (GPC, also known as SEC) at 23° C. using a styrene standard. This method is known to one skilled in the art. The polydispersity is derived from the average molecular weights Mw and Mn. It is calculated as PD=Mw/Mn.

“Oligomer” refers to a defined, small number of repeating monomer units such as 2-5,000 units, and advantageously 10-1,000 units which have been polymerized to form a molecule. Oligomers are a subset of the term polymer.

“Polyether” refers to polymers which contain multiple ether groups (each ether group comprising an oxygen atom connected top two hydrocarbyl groups) in the main polymer chain. The repeating unit in the polyether chain can be the same or different. Exemplary polyethers include homopolymers such as polyoxymethylene, polyethylene oxide, polypropylene oxide, polybutylene oxide, polytetrahydrofuran, and copolymers such as poly(ethylene oxide co propylene oxide), and EO tipped polypropylene oxide.

“Polyester” refers to polymers which contain multiple ester linkages. A polyester can be either linear or branched.

“Polymer” refers to any polymerized product greater in chain length and molecular weight than the oligomer. Polymers can have a degree of polymerization of about 20 to about 25000. As used herein polymer includes oligomers and polymers.

“Polyol” refers to a molecule comprising two or more —OH groups.

Room temperature refers a temperature of about 25° C.

“Substituted” refers to the presence of one or more substituents on a molecule in any possible position. Useful substituents are those groups that do not significantly diminish the disclosed reaction schemes. Exemplary substituents include, for example, H, halogen, (meth)acrylate, epoxy, oxetane, urea, urethane, N₃, NCS, CN, NCO, NO₂, NX¹X², OX¹, C(X¹)₃, C(halogen)₃, COOX¹, SX¹, Si(OX¹)iX²₃₋ᵢ, alkyl, alcohol, alkoxy; wherein X¹ and X² each independently comprise H, alkyl, alkenyl, alkynyl or aryl and i is an integer from 0 to 3.

“Sustainable” refers to a material made from renewable or sustainable resources, for example plant based sources. A material is substantially sustainable if it is comprised of at least 50% sustainable materials, preferably at least 75% sustainable materials, more preferably at least 90% sustainable materials and most preferably about 100% sustainable materials based on the weight of that material. Preferably, sustainable materials are derived partly or totally from non-food sources.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

This invention relates to two-component or two-part curable polymeric systems. In many embodiments one-component or one-part curable polymeric systems are not equivalent and would not be useful.

The first or A part of the two-part curable adhesive composition comprises one or more materials capable of reacting with isocyanate moieties to form a cured polymeric material. This component is referred to herein as “the isocyanate reactive A part”.

The second or B part of the two-part curable adhesive composition comprises one or more isocyanate functional materials having reactive isocyanate moieties.

### Isocyanate Reactive Part A

Part A comprises one or more isocyanate reactive components. An isocyanate reactive component is a compound containing one or more, preferably two or more, functional moieties that will react with an isocyanate moiety. Isocyanate reactive moieties include a hydroxyl moiety, an amine moiety, an olefin moiety, a thiol moiety, or a combination of these moieties.

One useful isocyanate reactive component is a polyol. A polyol is a compound containing more than one OH group in the molecule. A polyol can further have other functionalities other than OH on the molecule.

Some suitable polyol components include aliphatic alcohols containing 2 to 8 OH groups per molecule. The OH groups may be both primary and secondary. Some suitable aliphatic alcohols include, for example, ethylene glycol, propylene glycol, butane-1,4-diol, pentane-1,5-diol, hexane-1,6-diol, heptane-1,7-diol, octane-1,8-diol and higher homologs or isomers thereof which the expert can obtain by extending the hydrocarbon chain by one CH₂ group at a time or by introducing branches into the carbon chain. Also suitable are higher alcohols such as, for example, glycerol, trimethylol propane, pentaerythritol and oligomeric ethers of the substances mentioned either individually or in the form of mixtures of two or more of the ethers mentioned with one another.

Some suitable polyols include the reaction products of low molecular weight polyhydric alcohols with alkylene oxides, so-called polyether polyols. The alkylene oxides preferably contain 2 to 4 carbon atoms. Some reaction products of this type include, for example, the reaction products of ethylene glycol, propylene glycol, the isomeric butane diols, hexane diols or 4,4′-dihydroxydiphenyl propane with ethylene oxide, propylene oxide or butylene oxide or mixtures of two or more thereof. The reaction products of polyhydric alcohols, such as glycerol, trimethylol ethane or trimethylol propane, pentaerythritol or sugar alcohols or mixtures of two or more thereof, with the alkylene oxides mentioned to form polyether polyols are also suitable. Thus, depending on the desired molecular weight, products of the addition of only a few mol ethylene oxide and/or propylene oxide per mol or of more than one hundred mol ethylene oxide and/or propylene oxide onto low molecular weight polyhydric alcohols may be used. Other polyether polyols are obtainable by condensation of, for example, glycerol or pentaerythritol with elimination of water. Some suitable polyols include those polyols obtainable by polymerization of tetrahydrofuran.

The polyethers are reacted in a known manner by reacting the starting compound containing a reactive hydrogen atom with alkylene oxides, for example ethylene oxide, propylene oxide, butylene oxide, styrene oxide, tetrahydrofuran or epichlorohydrin or mixtures of two or more thereof.

Suitable starting compounds are, for example, water, ethylene glycol, 1,2- or 1,3-propylene glycol, 1,4- or 1,3-butylene glycol, hexane-1,6-diol, octane-1,8-diol, neopentyl glycol, 1,4-hydroxymethyl cyclohexane, 2-methyl propane-1,3-diol, glycerol, trimethylol propane, hexane-1,2,6-triol, butane-1,2,4-triol, trimethylol ethane, pentaerythritol, mannitol, sorbitol, methyl glycosides, sugars, phenol, isononylphenol, resorcinol, hydroquinone, 1,2,2- or 1,1,2-tris-(hydroxyphenyl)-ethane, ammonia, methyl amine, ethylenediamine, tetra- or hexamethylenediamine, triethanolamine, aniline, phenylenediamine, 2,4- and 2,6-diaminotoluene and polyphenylpolymethylene polyamines, which may be obtained by aniline/formaldehyde condensation, or mixtures of two or more thereof.

Some suitable polyols include diol EO/PO (ethylene oxide/propylene oxide) block copolymers, EO-tipped polypropylene glycols, or alkoxylated bisphenol A.

Some suitable polyols include polyether polyols modified by vinyl polymers. These polyols can be obtained, for example, by polymerizing styrene or acrylonitrile or mixtures thereof in the presence of polyetherpolyol.

Some suitable polyols include polyester polyols. For example, it is possible to use polyester polyols obtained by reacting low molecular weight alcohols, more particularly ethylene glycol, diethylene glycol, neopentyl glycol, hexanediol, butanediol, propylene glycol, glycerol or trimethylol propane, with caprolactone. Other suitable polyhydric alcohols for the production of polyester polyols are 1,4-hydroxymethyl cyclohexane, 2-methyl propane-1,3-diol, butane-1,2,4-triol, triethylene glycol, tetraethylene glycol, polyethylene glycol, dipropylene glycol, polypropylene glycol, dibutylene glycol and polybutylene glycol.

Some suitable polyols include polyester polyols obtained by polycondensation. Thus, dihydric and/or trihydric alcohols may be condensed with less than the equivalent quantity of dicarboxylic acids and/or tricarboxylic acids or reactive derivatives thereof to form polyester polyols. Suitable dicarboxylic acids are, for example, adipic acid or succinic acid and higher homologs thereof containing up to 16 carbon atoms, unsaturated dicarboxylic acids, such as maleic acid or fumaric acid, cyclohexane dicarboxylic acid (CHDA), and aromatic dicarboxylic acids, more particularly the isomeric phthalic acids, such as phthalic acid, isophthalic acid or terephthalic acid. Citric acid and trimellitic acid, for example, are also suitable tricarboxylic acids. The acids mentioned may be used individually or as mixtures of two or more thereof. Polyester polyols of at least one of the dicarboxylic acids mentioned and glycerol which have a residual content of OH groups are suitable. Suitable alcohols include but are not limited to propylene glycol, butane diol, pentane diol, hexanediol, ethylene glycol, diethylene glycol, triethylene glycol, dipropylene glycol, tripropylene glycol, cyclohexanedimethanol (CHDM), 2-methyl-1,3-propanediol (MPDiol), or neopentyl glycol or isomers or derivatives or mixtures of two or more thereof. High molecular weight polyester polyols may be used in the second synthesis stage and include, for example, the reaction products of polyhydric, preferably dihydric, alcohols (optionally together with small quantities of trihydric alcohols) and polybasic, preferably dibasic, carboxylic acids. Instead of free polycarboxylic acids, the corresponding polycarboxylic anhydrides or corresponding polycarboxylic acid esters with alcohols preferably containing 1 to 3 carbon atoms may also be used (where possible). The polycarboxylic acids may be aliphatic, cycloaliphatic, aromatic or heterocyclic or both. They may optionally be substituted, for example by alkyl groups, alkenyl groups, ether groups or halogens. Suitable polycarboxylic acids are, for example, succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acid or trimer fatty acid or mixtures of two or more thereof. Small quantities of monofunctional fatty acids may optionally be present in the reaction mixture.

The polyester polyol may optionally contain a small number of terminal carboxyl groups. Polyesters obtainable from lactones, for example based on ε-caprolactone (also known as “polycaprolactones”), or hydroxycarboxylic acids, for example ω-hydroxycaproic acid, may also be used.

Polyester polyols of oleochemical origin may also be used. Oleochemical polyester polyols may be obtained, for example, by complete ring opening of epoxidized triglycerides of a fatty mixture containing at least partly olefinically unsaturated fatty acids with one or more alcohols containing 1 to 12 carbon atoms and subsequent partial transesterification of the triglyceride derivatives to form alkyl ester polyols with 1 to 12 carbon atoms in the alkyl group.

Some suitable polyols include C36 dimer diols and derivatives thereof. Some suitable polyols include castor oil and derivatives thereof. Some suitable polyols include fatty polyols, for example the products of hydroxylation of unsaturated or polyunsaturated natural oils, the products of hydrogenations of unsaturated and polyunsaturated polyhydroxy natural oils, polyhydroxyl esters of alkyl hydroxyl fatty acids, polymerized natural oils, soybean polyols, and alkylhydroxylated amides of fatty acids.

Some suitable polyols include the hydroxy functional polybutadienes known, for example, by the commercial name of “Poly-bd®” available from Cray Valley USA, LLC Exton, PA.

Some suitable polyols include polyisobutylene polyols. Some suitable polyols include polyacetal polyols. Polyacetal polyols are understood to be compounds obtainable by reacting glycols, for example diethylene glycol or hexanediol or mixtures thereof, with formaldehyde. Polyacetal polyols may also be obtained by polymerizing cyclic acetals. Some suitable polyols include polycarbonate polyols. Polycarbonate polyols may be obtained, for example, by reacting diols, such as propylene glycol, butane-1,4-diol or hexane-1,6-diol, diethylene glycol, triethylene glycol or tetraethylene glycol or mixtures of two or more thereof, with diaryl carbonates, for example diphenyl carbonate, or phosgene. Some suitable polyols include polyamide polyols.

Some suitable polyols include polyacrylates containing OH groups. These polyacrylates may be obtained, for example, by polymerizing ethylenically unsaturated monomers bearing an OH group. Such monomers are obtainable, for example, by esterification of ethylenically unsaturated carboxylic acids and dihydric alcohols, the alcohol generally being present in a slight excess. Ethylenically unsaturated carboxylic acids suitable for this purpose are, for example, acrylic acid, methacrylic acid, crotonic acid or maleic acid. Corresponding OH-functional esters are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate or mixtures of two or more thereof.

The isocyanate reactive component can be a polyamine. A polyamine is a compound contains more than one —NHR group where R can be a covalent bond, H, hydrocarbyl, heterohydrocarbyl. A polyamine can further have functionalities other than amine on the molecule. The amine moieties can be primary amine moieties, secondary amine moieties, or combinations of both. In some embodiments the compound comprises two or more amine moieties independently selected from primary amine moieties and secondary amine moieties. In some embodiments the compound can be represented by the structure HRN—Z—NRH where Z is a hydrocarbyl group having 1 to 20 carbon atoms and R can be a covalent bond, H, hydrocarbyl, heterohydrocarbyl or polyether. In some embodiments Z is a straight or branched alkane diradical or a straight or branched polyether diradical. In some embodiments Z can be a heterohydrocarbyl diradical. In some embodiments Z can be a polymeric and/or oligomeric backbone. Such polymeric/oligomeric backbone can contain ether, ester, urethane, acrylate linkages. In some embodiments R is H.

Some suitable polyamine compounds include aliphatic polyamines, arylaliphatic polyamines, cycloaliphatic polyamines, aromatic polyamines, heterocyclic polyamines, polyalkoxypolyamines, and combinations thereof. The alkoxy group of the polyalkoxypolyamines is an oxyethylene, oxypropylene, oxy-1,2-butylene, oxy-1,4-butylene or a co-polymer thereof.

Examples of aliphatic polyamines include, but are not limited to ethylenediamine (EDA), diethylenetriamine (DETA), triethylenetetramine (TETA), trimethyl hexane diamine (TMDA), hexamethylenediamine (HMDA), N-(2-aminoethyl)-1,3-propanediamine (N3-Amine), N,N′-1,2-ethanediylbis-1,3-propanediamine (N4-amine), and dipropylenetriamine. Examples of arylaliphatic polyamines include, but are not limited to m-xylylenediamine (mXDA), and p-xylylenediamine. Examples of cycloaliphatic polyamines include, but are not limited to, 1,3-bisaminocyclohexylamine (1,3-BAC), isophorone diamine (IPDA), and 4,4′-methylenebiscyclohexanamine. Examples of aromatic polyamines include, but are not limited to diethyltoluenediamine (DETDA), m-phenylenediamine, diaminodiphenylmethane (DDM), and diaminodiphenylsulfone (DDS). Examples of heterocyclic polyamines include, but are not limited to N-aminoethylpiperazine (NAEP), and 3,9-bis(3-aminopropyl) 2,4,8,10-tetraoxaspiro(5,5)undecane. Examples of polyalkoxypolyamines where the alkoxy group is an oxyethylene, oxypropylene, oxy-1,2-butylene, oxy-1,4-butylene or a co-polymer thereof include, but are not limited to 4,7-dioxadecane-1, 10-diamine, 1-propanamine,2, I-ethanediyloxy))bis(diaminopropylated diethylene glycol). Suitable commercially available polyetheramines include those sold by Huntsman under the Jeffamine® trade name. Suitable polyether diamines include Jeffamines® in the D, SD, ED, XTJ, and DR series. Suitable polyether triamines include Jeffamines® in the T and ST series.

Suitable commercially available polyamines also include aspartic ester-based amine-functional resins (Bayer); dimer diamines e.g. Priamine® (Croda); or diamines such as Versalink® (Evonik).

The isocyanate reactive part can be a polythiol having two or more —SH moieties. The polythiol can have functionalities other than thiol on the molecule, for example —OH, —NH, —NH₂, —COOH, or epoxide. In some embodiments the polythiol can be represented by the structure HS—Z—SH where Z is a hydrocarbyl group, a heterohydrocarbyl group having 1 to 50 carbon atoms. In some embodiments Z is a straight or branched alkane or a straight or branched polyether. Some suitable polythiols include but are not limited to pentaerythritol tetra-(3-mercaptopropionate) (PETMP), pentaerythritol tetrakis(3-mercaptobutylate) (PETMB), trimethylolpropane tri-(3-mercaptopropionate) (TMPMP), glycol di-(3-mercaptopropionate) (GDMP), pentaerythritol tetramercaptoacetate (PETMA), trimethylolpropane trimercaptoacetate (TMPMA), glycol dimercaptoacetate (GDMA), ethoxylated trimethylpropane tri(3-mercapto-propionate) 700 (ETTMP 700), ethoxylated trimethylpropane tri(3-mercapto-propionate) 1300 (ETTMP 1300), propylene glycol 3-mercaptopropionate 800 (PPGMP 800), propylene glycol 3-mercaptopropionate 2200 (PPGMP 2200), pentaerythritol tetrakis(3-mercaptobutanoate) (KarenzMT PE-1 from Showa Denko), and soy polythiols (Mercaptanized Soybean Oil).

The isocyanate reactive part can be an aminoalcohol. An aminoalcohol is a compound having at least one amino moiety and at least one hydroxyl moiety. In some embodiments the amine group is terminal to the aminoalcohol compound molecule. In some embodiments the amine group is a secondary amino group on the chain of the aminoalcohol compound molecule. In some embodiments the aminoalcohol compound includes a terminal primary amine and a secondary amine. In some embodiments the aminoalcohol compound can be represented by one of the following structures: HO—Z—NH—Z—OH or H₂N—Z—NH—Z—OH or H₂N—Z—(OH)₂ where Z is a hydrocarbyl group and/or an heterohydrocarbyl having 1 to 50 carbon atoms. In some embodiments Z is a straight or branched alkane or a straight or branched polyether. In some embodiments Z contains cycloaliphatic moiety or aryl moiety. Some suitable aminoalcohols include but are not limited to diethanolamine, dipropanolamine, 3-amino-1,2-propanediol, 2-amino-1,3-propane diol, 2-amiono-2-methyl-1,3-propanediol, diisopropanolamine. The aminoalcohol compound encompasses a single compound or a mixture of two or more aminoalcohol compounds.

Any of the above isocyanate reactive components can be useful. However, to maximize the sustainable content of the adhesive composition at least some, preferably most and more preferably all of the isocyanate reactive components except for additives are sustainable materials. In some preferred embodiments most or all of the isocyanate reactive components except for additives are sustainable materials from non-food chain sources. These embodiments would exclude isocyanate reactive materials that are not sustainable from the part A composition. A plurality of sustainable isocyanate reactive materials are known. Castor oil and glycerol are useful sustainable isocyanate reactive materials available from non-food chain sources. U.S. Pat. Nos. 6,891,053, 8,757,294 and 8,575,378 disclose methods of making modified plant-based polyols. U.S. Pat. No. 10,294,328 discloses a method of making a transesterified polyol from natural oils and poly lactic acid. Other sustainable isocyanate reactive components are available commercially such as hydroxylated plant oils (also known as bio-based polyols), for example, hydroxylated versions of soybean oil almond oil, canola oil, coconut oil, cod liver oil, corn oil, cottonseed oil, flaxseed oil, linseed oil, olive oil, palm oil, peanut oil, safflower oil, sesame oil, sunflower oil, walnut, castor oil.

Combinations of two or more isocyanate reactive components can be used in part A. Alternatively, part A can be formulated to exclude any particular isocyanate reactive material not essential to the adhesive composition.

Part A preferably has a viscosity of not greater than about 100,000 cps (more preferably, not greater than about 80,000 cps; most preferably, not greater than about 75,000 cps) at 25 degrees C.

### Isocyanate Functional Part B

Part B comprises one or more polyisocyanates. Suitable polyisocyanates include monomeric polyisocyanates; modified monomeric polyisocyanates; polymeric polyisocyanates such as polymeric MDI; and isocyanate functional prepolymers.

The B part preferably has a weight average isocyanate functionality of about 2.0 to about 3.3. The weight average functionality of a part B mixture of polyisocyanates (fNCO) is calculated as follows: fNCO=(wt. % polyisocyanate 1*f polyisocyanate 1)+(wt. % polyisocyanate i*f polyisocyanate i)+ . . . In other words, the weight average functionality is the sum of each weight % of a given polyisocyanate based on the total part B weight multiplied by its functionality.

Part B preferably has a viscosity of not greater than about 30,000 cps (more preferably, not greater than about 25,000 cps; most preferably, not greater than about 20,000 cps) at 25 degrees C. If part B comprises polyurethane prepolymers, those prepolymers may have a molecular weight (Mn) of from 500 to 27,000, alternatively from 700 to 15,000, or alternatively from 700 to 8,000 g/mol.

Useful monomeric polyisocyanates include 4,4′-diphenylmethane diisocyanate (4,4′ MDI) and its 2,4-diphenylmethane diisocyanate (2,4′-MDI), and 2,2′ diphenylmethane diisocyanate (2,2′-MDI) isomers; hexane 1,6-diisocyanate (HDI); hydrogenated MDI (H12MDI); toluene diisocyanate (TDI) and its isomers. Monomeric polyisocyanates having monomeric forms can be used as a single isomer or any combination of isomers. For example, diphenylmethane diisocyanate (MDI) is available in three isomeric forms. Mixtures of two or more of these isomers can be used for some or all of the polyisocyanate. Alternatively, one or more of these isomers can be excluded.

Modified monomeric polyisocyanates comprise polyisocyanates in which 1% or more of the isocyanate groups have been modified to a carbodiimide, allophanate, biuret or polymeric form. For example, modified versions of diphenylmethane diisocyanate (MDI) include e.g., carbodiimide-modified diphenylmethane diisocyanate (carbodiimide-modified MDI), allophanate-modified diphenylmethane diisocyanate (allophanate-modified MDI), biuret-modified diphenylmethane diisocyanate (biuret-modified MDI), polymeric MDI and combinations thereof.

Polyurethane prepolymers comprise the reaction product of a polyol or polyamine with an excess of one or more polyisocyanates. The reaction product is a polyurethane or polyurea having reactive isocyanate moieties on the molecule. Any of the above polyols or polyamines are useful. However, to maximize the sustainable content of the adhesive composition it is preferred that some or all of the polyol(s) and/or polyamines used to form the polyurethane prepolymer are sustainable materials.

Combinations of two or more polyisocyanates can be used in part B. Alternatively, part B can be formulated to exclude any particular polyisocyanate not essential to the adhesive composition.

MDI, modified MDI, polymeric MDI and polyurethane prepolymers prepared using MDI are preferred for use in part B.

### Reactive Rheology Modifier

The adhesive composition includes a sustainable reactive rheology modifier. Useful sustainable reactive rheology modifiers include waxes derived from sustainable sources such as sunflower wax, soybean wax, carnauba wax, laurel wax, candelilla wax, rice bean wax, berry wax, natural beeswax, synthetic beeswax and myrica fruit wax. Unless specified beeswax includes natural beeswax and synthetic beeswax. In some embodiments the composition is essentially free or free of reactive rheology modifiers based on castor oil or castor oil derivatives. Preferably the sustainable reactive rheology modifier is from a non-food source. Useful sustainable reactive rheology modifiers from a non-food source include natural or synthetic beeswax and more preferably natural beeswax. Natural beeswax is the byproduct after honey is removed from bee hive honeycombs. The beeswax is cleaned to remove extraneous materials and formed into shapes suitable for subsequent use. Natural beeswax is a sustainable material commercially available, for example from Koster Keunen in Connecticut US.

Natural beeswax is a complex product that is secreted in liquid form by special wax glands in the abdomen of younger worker bees. In contact with the air, it solidifies in scales (that the bees model with jaws to build the honeycombs. Natural beeswax is chemically different from commercially available synthetic homopolymer and copolymer waxes but is chemically related to synthetic beeswax.

When secreted by the bee, the pure beeswax is almost white; only after contact with honey and pollen it assumes a variably intense yellowish color and turns brown after about four years. Beeswax resists the action of acids and gastric juices of honeybees and is insoluble in water and cold alcohol; it dissolves partially in boiling alcohol, and completely in chloroform, in carbon disulfide, and in the essence of hot turpentine. When the wax is treated with boiling alcohol the part that melts is formed by cerotic acid, free or mixed with small amounts of melissic acid, while the one that does not dissolve is formed by ether-melisil palmitic mixed with small amounts of ethers compounds of palmitic and stearic acid. Beeswax has a density at 15° C. of about 0.960 kg/m³ to 0.970 kg/m³ and it melts at temperatures between 63.5° C. and 64.5° C.

Natural beeswax is a complex mixture (more than 300 components) of hydrocarbons, free fatty acids, esters of fatty acids and fatty alcohol, diesters and exogenous substances.

Natural beeswax can comprise: 12% to 16% hydrocarbons with a predominant chain length of C27-C33, mainly heptacosane, nonacosane, hentriacontane, pentacosane and tricosane; 12% to 14% of free fatty acids with a chain length of C24-C32; about 1% of free fatty alcohols with a chain length of C28-C35; 35% to 45% of linear wax monoesters and hydroxymonoesters with chain lengths generally of C40-C48, derived fundamentally from palmitic, 15-hydroxypalmitic and oleic acids; 15% to 27% complex wax esters containing 15-hydroxypalmitic acid or diols linked to another fatty-acid molecule; exogenous substances that are mainly residues of propolis, pollen, small pieces of floral component factors and pollution. Naturally the composition of beeswax will vary between and among the different families and different breeds of bees and in different geographic regions. See, for example, Beeswax: A minireview of its antimicrobial activity and its application in medicine; Asian Pacific Journal of Tropical Medicine; Volume 9, Issue 9, September 2016, Pages 839-843.

Natural beeswax is a complex combination of long chain organic materials having unsaturation (C═C bonds) as well as hydroxy acid (CHOH) and hydroxyl (OH) functionality in the molecules. Analysis shows one sample of sustainable beeswax had 0.7% unsaturation, 1.0% hydroxy acid and 0.5% hydroxyl content.

Synthetic beeswax is a manmade form of beeswax made to recreate the major constituents of natural beeswax. Synthetic beeswax is commercially available, for example from Koster Keunen in Connecticut US.

Beeswax reacts with isocyanate moieties in part B and therefore must be a component of only part A. One problem is beeswax is not compatible with most other isocyanate reactive materials in part A. This incompatibility results in the beeswax separating out of the part A composition as a solid, making the part A composition unusable. Applicants' have surprisingly discovered that shear mixing beeswax with glycerol creates a stable dispersion that can be added to other isocyanate reactive materials to form part A.

### Additives:

The two-component polyurethane adhesive composition can optionally contain one or more additives.

The two component curable composition can optionally include other additives such as catalyst, filler, additional thixotrope or rheology modifier, antioxidant, reaction modifier, thermoplastic polymer, adhesion promoter, coloring agent, solvent, tackifier, plasticizer, flame retardant, diluent, reactive diluent, moisture scavenger, and combinations of any of the above, to produce desired functional characteristics, providing they do not significantly interfere with the desired properties of the curable composition or cured reaction products of the curable composition.

The curable adhesive compositions can optionally include a catalyst or cure-inducing component to modify speed of the initiated reaction. Some suitable catalysts are those conventionally used in polyurethane reactions and polyurethane curing, including organometallic catalysts, organotin catalysts and amine catalysts. Exemplary catalysts include (1,4-diazabicyclo[2.2.2]octane) DABCO® T-12 or DABCO® crystalline, available from Evonik; DMDEE (2,2′-dimorpholinildiethylether); DBU (1,8-diazabicyclo[5.4.0]undec-7-ene). When used, the curable composition can include from about 0.01% to about 5% catalyst by weight of composition.

The curable composition can optionally include filler. Some useful fillers include, for example, lithopone, zirconium silicate, hydroxides, such as hydroxides of calcium, aluminum, magnesium, iron and the like, diatomaceous earth, carbonates, such as sodium, potassium, calcium, and magnesium carbonates, oxides, such as zinc, magnesium, chromic, cerium, zirconium and aluminum oxides, calcium clay, nanosilica, fumed silicas, silicas that have been surface treated with a silane or silazane such as the AEROSIL® products available from Evonik Industries, silicas that have been surface treated with an acrylate or methacrylate such as AEROSIL® R7200 or R711 available from Evonik Industries, precipitated silicas, untreated silicas, graphite, synthetic fibers, organoclays such as Cloisite® nanoclay sold by Southern Clay Products, exfoliated graphite such as xGnP® graphene nanoplatelets sold by XG Sciences and combinations thereof. When used, the curable composition can include filler in amounts up to about 90% by weight of composition, more typically 1% to 30% by weight of composition.

The curable composition can optionally include a thixotrope or rheology modifier. The thixotropic agent can modify rheological properties of the uncured composition. Some useful thixotropic agents include, for example, sustainably derived organic materials, for example the castor oil derivatives Rheocin available from BYK; Thixcin available from Elementis and Albothix available from Alberdingk Boley; silicas, such as fused or fumed silicas, that may be untreated or treated so as to alter the chemical nature of their surface. Virtually any reinforcing fused, precipitated silica, fumed silica or surface treated silica may be used. Examples of treated fumed silicas include polydimethylsiloxane-treated silicas, hexamethyldisilazane-treated silicas and other silazane or silane treated silicas. Such treated silicas are commercially available, such as from Cabot Corporation under the tradename CAB-O-SIL® ND-TS and Evonik Industries under the tradename AEROSIL®, such as AEROSIL® R805. Also useful are the silicas that have been surface treated with an acrylate or methacrylate such as AEROSIL® R7200 or R711 available from Evonik Industries. Examples of untreated silicas include commercially available amorphous silicas such as AEROSIL® 300, AEROSIL® 200 and AEROSIL® 130. Commercially available hydrous silicas include NIPSIL® E150 and NIPSIL® E200A manufactured by Japan Silica Kogya Inc. When used, the curable composition can include about 0% to about 50% thixotrope by weight of the composition and advantageously in concentrations of about 0% to about 20% by weight of the composition. In certain embodiments the filler and the rheology modifier can be the same.

The curable composition can optionally include a reaction modifier. A reaction modifier is a material that will increase or decrease reaction rate of the curable composition. For example, 8-hydroxyquinoline (8-HQ) and derivatives thereof such as 5-hydroxymethyl-8-hydroxyquinoline can be used to adjust the cure speed. When used, the curable composition can include about 0.001 to about 15 weight percent of reaction modifier by weight of the curable composition.

The curable composition can optionally contain a thermoplastic polymer. The thermoplastic polymer may be either a functional or a non-functional thermoplastic. Non-limiting examples of suitable thermoplastic polymers include acrylic polymer, functional (e.g. containing reactive moieties such as —OH and/or —COOH) acrylic polymer, non-functional acrylic polymer, acrylic block copolymer, acrylic polymer having tertiary-alkyl amide functionality, polysiloxane polymer, polystyrene copolymer, divinylbenzene copolymer, polyetheramide, polyvinyl acetal, polyvinyl butyral, polyvinyl chloride, methylene polyvinyl ether, cellulose acetate, styrene acrylonitrile, amorphous polyolefin, olefin block copolymer [OBC], polyolefin plastomer, thermoplastic urethane, polyacrylonitrile, ethylene acrylate copolymer, ethylene acrylate terpolymer, ethylene butadiene copolymer and/or block copolymer, styrene butadiene block copolymer, and mixtures of any of the above. When used, the curable composition can include about 1% to about 20% weight percent of thermoplastic polymer by weight of the curable composition.

The curable composition can optionally include one or more adhesion promoters that are compatible and known in the art. When used, the curable composition can include about 0% to about 20% percent adhesion promoter by weight of curable composition and advantageously about 0.1% to about 15% percent by weight of curable composition.

The curable composition can optionally include one or more coloring agents. For some applications a colored composition can be beneficial to allow for inspection of the applied composition. A coloring agent, for example a pigment or dye, can be used to provide a desired color beneficial to the intended application. Exemplary coloring agents include titanium dioxide, C.I. Pigment Blue 28, C.I. Pigment Yellow 53 and phthalocyanine blue BN. In some applications a fluorescent dye can be added to allow inspection of the applied composition under UV radiation. When used, the curable composition can include about 0.002% or more coloring agent by weight of total composition. The maximum amount is governed by considerations of cost, absorption of radiation and interference with cure of the composition.

The additives can be contained in part A, part B or both as long as the additive does not deleteriously react with other components in that part.

In one embodiment part A of the two component curable composition has the following composition. All percentages are weight percent by weight of part A. Typically, part A will be a liquid to flowable semisolid at room temperature with a viscosity of about 5,000 to about 100,000 cP at either 2 rpm or 20 rpm.

| component | range 1 | range 2 |
|---|---|---|
| sustainable isocyanate | 50%-95% | 80%-97% |
| reactive component | | |
| isocyanate reactive | 0%-95% | 0%-97% |
| component | | |
| beeswax | 0.5%-20% | 2%-15% |
| glycerol | 0.5%-10% | 1%-5% |
| additives | 0%-80 | 0%-80 |
| sustainable component | 50%-100% | 70%-100% |
| content | | |

The isocyanate reactive component is optional and represents any non-sustainable isocyanate reactive component content. Preferably, there is no non-sustainable isocyanate reactive component content so that the non-additive components in part A are all sustainably sourced.

Typically, the part A components are added together and heated with stirring to a temperature sufficient to melt the reactive rheology modifier. Once blended the heat is removed and the mixture allowed to cool. The mixture will thicken and cloud as it cools. Once cooled the part A composition is packaged to exclude air and moisture.

In one embodiment part B of the two component curable composition has the following composition. All percentages are weight percent by weight of part B. Typically, part B will have viscosity of about 8,000 to about 30,000 cPs at 20 rpm. Since the B side is not typically thixotropic the viscosity will generally be the same at 2 rpm.

| component | | |
|---|---|---|
| polyisocyanate | 30%-100% | 50%-100% |
| isocyanate reactive | 0%-70% | 0%-60% |
| component | | |
| additives | 0%- | 0%- |
| sustainable component | 0%-50% | 0%-50% |
| content | | |

Part B can be prepared by adding the non-isocyanate containing components to a reactor and heating while stirring and under vacuum to remove moisture. If a sustainable isocyanate reactive component is used in part B it can be added with the other non-isocyanate components. Once moisture is removed the isocyanate containing components can be added. Mixing under vacuum is continued until the mixture is homogeneous and the desired isocyanate content is reached. The mixed part B is cooled and packaged into container sealed to prevent moisture ingress.

In one embodiment the mixed curable composition has the following properties.

| property | range 1 | range 2 |
|---|---|---|
| index¹ | 1.05-1.3 | 1.1-1.2 |
| viscosity, 2 rpm (cPs) | 30,000-100,000 | 40,000-90,000 |
| viscosity, 20 rpm (cPs) | 6,000-30,000 | 7,000-20,000 |
| open time (minutes) | 5-40 | 15-30 |
| gel time (minutes) | 15-60 | 20-45 |
| cure time (minutes) | 20-60 | 20-60 |
| membrane penetration (%) | 0-100 | 0-50 |
| sustainable component | 3%-85% | 3%-80% |
| content² | | |

¹Index is (number of isocyanate groups/number of groups reacting with the isocyanate) × 100.
²Sustainable component percentage is (sustainable components in part A + sustainable components in part B)/2.

In one embodiment a cured reaction product of the mixed curable composition has the following properties.

| property | range 1 | range 2 |
|---|---|---|
| hardness (Shore A) | 40-95 | 50-90 |
| hardness (Shore D) | 10-50 | 15-45 |
| chemical resistance 50° C. (%) | <±2 | <±1 |
| chemical resistance 80° C. | <±2 | <±1 |

In some embodiments it is preferred that the adhesive composition is a homogeneous solid free of gases, e.g. it is not foamed. In these embodiments the composition parts and mixed adhesive composition are free of blowing agents.

### Use of the Adhesive Composition Made Using the Disclosed 2 Part Adhesive Composition:

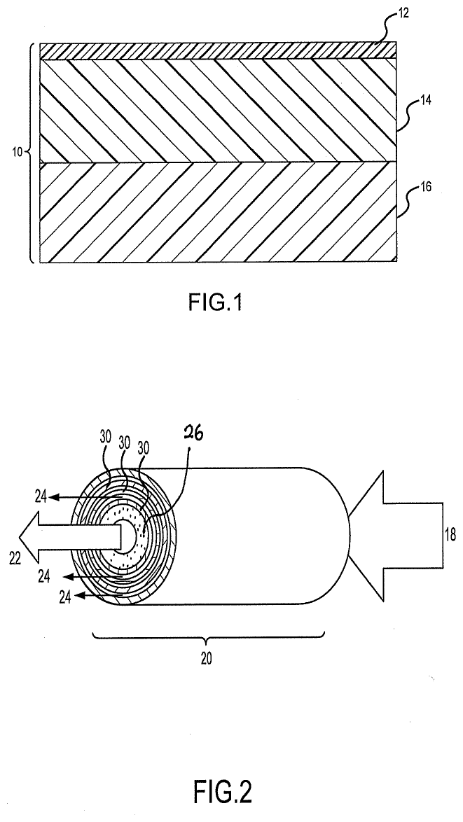

The following description refers to FIGS. 1-4.

A typical thin-film composite membrane 10 intended for a spiral wrapped filtration system, for example a reverse osmosis and/or nanofiltration system, has the general structure shown as a schematic cross-section in FIG. 1. In one embodiment the membrane 10 comprises two or three layers: a thin, dense semi-permeable barrier layer 12 overlying a microporous substrate 14, the microporous substrate 14 optionally overlying a porous support layer 16. The porous support layer 16 can be, for example, a non-woven polyester layer. The porous support layer 16 is generally constructed and arranged to allow fluid to pass through it easily, while providing physical support for the other layers of the composite membrane 10. Likewise, the semi-permeable barrier layer 12 is commonly, but not necessarily a polyamide, and the microporous substrate 14 is usually but not always comprised of a polysulfone. The materials of construction and their thickness, etc. may be varied depending on the exact separation application for which the membrane 10 is intended to be used.

The semi-permeable layer 12 is the active surface of the membrane 10 and is usually considered to be affecting the separation, either on its own or in combination with the intermediate microporous substrate 14, depending on the exact nature of the compounds being separated. For instance, if the membrane 10 is intended to be used to purify water, the membrane 10 will allow water to pass through, but not contaminants or salt ions.

A plurality of these membranes 10 are bonded together into a spiral-wound membrane element, using the two-component polyurethane adhesive prepared by mixing the disclosed part A and part B.

FIGS. 2-4 show together, a typical spiral-wound membrane element 20 (FIG. 2) and the various components and the construction of the spiral-wound membrane element 20.

FIG. 2 shows schematically one embodiment of a spiral-wound membrane element 20 comprised of a center perforated permeate tube 26, around which is wound one or more membrane leaf elements 30 (shown in FIG. 4). These membrane leaf elements 30 are described in more detail below. Each membrane leaf element may be separated by a feed spacer 28, typically a polymeric net structure. A feed stream 18 enters the spiral-wound membrane element 20 flowing through the space between membranes provided by the feed spacer 28. The feed stream 18 is comprised of at least two constituents. A typical illustrative example of the feed stream 18 would be salt water having an initial concentration of salt, which then would be separated by the membranes 10 into a permeate stream 22 of clean water and a concentrate stream 24 comprised of water with a higher concentration of salt than the feed stream 18. The permeate stream 22 is directed spirally into the permeate tube 26 and discharged therefrom. The concentrate stream 24 flows between the membrane leaf elements 30 and is discharged.

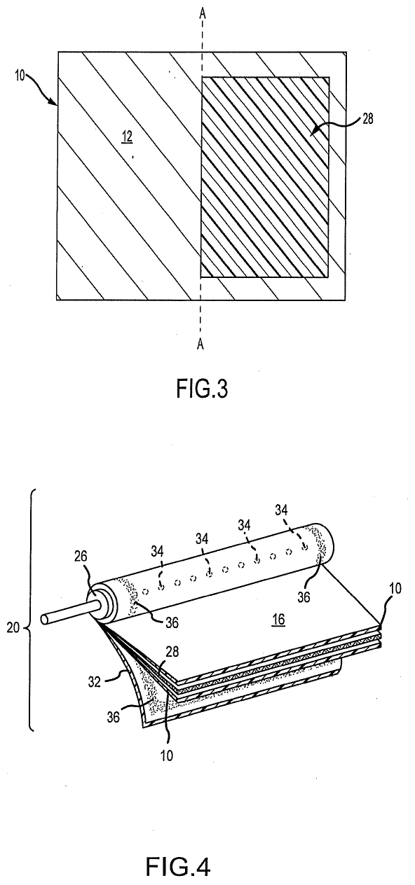

The typical construction of a spiral-wound membrane element 20 is known in the art and one variation comprises generally the following steps. As shown in FIG. 3, the sheet of the membrane 10 is laid out and folded in half along line A-A, such that the semi-permeable layer 12 is facing toward the inside of the folded sheet 10 and the support layer 16 (not visible in FIG. 3) is on the outside. A layer of feed spacer or feed carrier 28 is placed inside the folded sheet 10. The feed spacer or feed carrier layer 28 is intended to provide space so that the feed 18 can flow freely inside the folded membrane sheet 10. The particular details of the materials and thickness of the feed carrier 28 depend on the intended application of the spiral-wound membrane element 20, but usually it is a non-woven material that allows free flow of the feed stream 18 between the adjacent folded portions of membrane sheet 10. Note that the feed carrier 28 may be slightly smaller than the folded membrane sheet 10, as shown schematically in FIG. 3.

FIG. 4 shows one embodiment of a membrane leaf element 30 as it is being wound around the permeate tube 26. As is known in the art, on or more of these membrane leaf elements 30 are wound around the permeate tube 26, although only one is shown in FIG. 4. The membrane leaf element 30 comprises generally three parts. These are a porous permeate carrier layer 32, the folded membrane sheet 10, and the feed spacer 28 which is placed between the folded membrane sheet 10.

During construction of the membrane leaf element 30 the porous permeate carrier layer 32 is bonded to the center perforated permeate tube 26. The two-component polyurethane adhesive 36 described herein can optionally be used for this bonding. The porous permeate carrier 32 is constructed and arranged to allow the permeate 22 to flow into the permeate tube 26. The permeate tube 26 has a plurality of perforations 34 that allow the permeate 22 to flow into permeate tube 26 and thus out the spiral-wound membrane element 20.

The two-component polyurethane adhesive 36 described herein can optionally also be used to bond the folded membrane sheet 10 and the permeate carrier 32 on three sides which forms an envelope that is open to the permeate tube 26 but closed to the feed. The method of applying the two-component polyurethane adhesive 36 is not particularly limited and suitable methods are known to the skilled person. For instance, the components of two-component polyurethane adhesive 36 can be separately dispensed as needed from tubes or other containers and mixed in a static mixer just before use. The mixed adhesive 36 may be applied as a continuous bead along the open edges of the porous permeate carrier 32, as seen in FIG. 4. The bead size is not particularly limited but it should bond only the edges of folded sheet 10 to the permeate carrier 32, leaving the interior portion of each unbonded. Suitable bead widths can be for instance about 0.3 cm to about 2 cm or about 0.3 cm to about 0.6 cm. The membrane 10 is disposed over permeate carrier 32 and adhesive 36 with fold (line A-A in FIG. 2) on the membrane sheet 10 positioned along the permeate tube 26. Ideally, the adhesive 36 will penetrate 90% or more into some or all of the layers (porous support layer 16, microporous layer 14 and the barrier layer 12 shown in FIG. 1) of the membrane 10 and permeate carrier 32. However, lesser penetration, even down to 5%, has been shown to provide acceptable performance in some bonding spiral wound membrane components.

This bonding process, i.e. bonding the porous permeate carrier layer 32 to the center perforated permeate tube 26, and then bonding the folded membrane sheet 10 (that has the feed carrier 28 between the folded sheet 10) to the porous permeate carrier layer 32 on three sides, to form a membrane leaf element 30 is repeated as many times as necessary until the desired number of membrane leaf elements are attached to the permeate tube 26. The membrane leaf elements 30 are then wound tightly around the permeate tube 26 to form the spiral-wound element 20.

The cap, sometimes called an anti telescope device, is a molded plastic component that holds the wound membrane leaves in place so they cannot move axially under pressure and ensures load is transmitted equally among all components of the filter assembly. In some embodiments the cap can be bonded to the membrane element using the disclosed two-component polyurethane adhesive.

### EXAMPLES

### Preparation of Part A:

The part A components are added together and heated to 80° C. with stirring until all ingredients were melted and mixed. Once mixed the heat is removed and the mixture allowed to cool with continued mixing. Once cooled the part A composition is packaged to exclude air and moisture.

### Part B:

LOCTITE UK178B from Henkel Corporation was used as the part B isocyanate functional composition for all samples. Mondur CD was added to the part B samples to ensure the index remained between 1.1 and 1.2 for all samples.

### Preparation of the Two-Component Polyurethane Adhesive Composition:

Part A and Part B were mixed to homogeneity at a 1:1 ratio by volume. The mixed compositions had an index (NCO: NCO reactive) of about 1.1:1 to 1.2:1.

### Viscosity:

Samples of part A and part B were at room temperature (23-25 C) prior to testing. For the mixed composition, separate portions of part A and part B were homogeneously mixed through a static mixer. Testing was done using at 25° C. using a Brookfield viscosimeter with a #6 spindle. 2 rpm testing was done within 1 minute of mixing. 20 rpm testing was done within 2 minutes of mixing. Viscosity results are in cPs.

### Thixotropic Index:

The thixotropic of the material is calculated by dividing the viscosity of the sample taken at 2 rpm and dividing by the viscosity of the sample taken at 20 rpm. The thixotropic index can be calculated for each individual component, as well as for the mixed sample.

### Open Time:

Open time is the time it takes for the mixed sample to double (2×) the 20 rpm viscosity.

### Gel Time:

Gel time is the time it takes for the mixed sample to triple (3×) the 20 rpm viscosity.

### Shore Hardness:

Samples were prepared by dispensing the 1:1 part A: part B mixture through a static mixer into a 100 g plastic beaker. The material was allowed to cure for 24 h, after which time the cured 100 G puck was removed from the beaker. The puck was about 2 in diameter and 3″ thick. Measurement of the samples was carried out in accordance with ASTM D2240.

### Measuring Percent Penetration of the Membrane by the Adhesive.

Squares of membrane (approximately 7.5 cm×7.5 cm) were placed on the porous support layer 16. Approximately 5 grams of the mixed adhesive was placed on that membrane. The porous support layer 16 of a second membrane was placed on top of the mixed adhesive. A non-stick plastic square (polyethylene, dimensions approximately 12 cm×12 cm) was placed on top of the assembled membranes. An approximately 450 gram weight was then placed over the top of the entire non-stick plastic square. The weight was left for 20 minutes and then removed. The assembly was allowed to cure for at least 8 hours and the percent penetration was evaluated visually and reported as membrane penetration. Unless otherwise noted FILMTEC™ BW30 membranes were used for penetration testing.

Penetration was qualitatively estimated by visual analysis of the ratio of dark area to light area on the back side (i.e. on the barrier layer side 12 opposite the support layer 16). No visual change would be 100% light area and would correspond to 0% penetration. Complete penetration would be 100% dark area and would correspond to 100% penetration. The samples were evaluated side-by-side by more than one person to ensure consistency.

### Example 1

The following part A compositions were prepared or provided. All amounts are % by weight of that part. Comparative example A used LOCTITE UK178A from Henkel Corporation as the part A isocyanate reactive composition.

| | A | 1 | 2 | 3 | 4 |
|---|---|---|---|---|---|
| castor oil (wt. %) | — | 95 | 93 | 92 | 91 |
| beeswax (wt. %) | — | 5 | 5 | 5 | 5 |
| glycerol (wt. %) | — | 0 | 2 | 3 | 4 |
| viscosity 2 rpm | 40000 | 56000 | 44000 | 55500 | 62500 |
| viscosity 20 rpm | 13200 | 16800 | 13200 | 15200 | 17700 |

Sample 1 had a part A comprising beeswax with no glycerol. The sample 1 part A composition exhibited instability with the beeswax separating out as a solid phase from the other ingredients in only 5 to 10 minutes. Adding glycerol to the part A composition with heating and mixing as in Examples 2, 3 and 4 stabilized the composition, maintaining the beeswax in the composition with little or no separation after 30 minutes.

Addition of glycerol was also surprisingly effective at lowering viscosity of the part A composition. Surprisingly, this viscosity lowering effect is limited. Samples 2 and 3 illustrate how the viscosity is lowered compared to Sample 1 with no glycerol. Sample 4 illustrates that adding more than about 3% glycerol to the part A composition actually increases the part A viscosity compared to Sample 1 with no glycerol. This increase in viscosity with increasing glycerol content is surprising as glycerol has a viscosity of only about 1412 cPs.

LOCTITE UK178B from Henkel Corporation was used as the part B isocyanate functional composition for all samples. Mondur CD was added to the part B samples to ensure the index remained between 1.1 and 1.2 for all samples. Each part A composition was mixed 1:1 by volume with the LOCTITE UK178B part B composition. All amounts are % by weight of that part. Cured composition physical test results for the mixed adhesive composition are shown below.

| | A | 1 | 2 | 3 | 4 |
|---|---|---|---|---|---|
| part A | | | | | |
| castor oil (wt. %) | — | 95 | 93 | 92 | 91 |
| beeswax (wt. %) | — | 5 | 5 | 5 | 5 |
| glycerol (wt. %) | — | 0 | 2 | 3 | 4 |
| part B | | | | | |
| LOCTITE | 100 | 100 | 100 | 100 | 100 |
| UK178B | | | | | |
| thixotropic index | 3.0 | 3.3 | 3.3 | 3.6 | 3.5 |
| open time | 23 | 26 | 30 | 23 | 24 |
| gel time | 34 | 33 | 40 | 27 | 28 |
| Shore A¹ | 95 | 74 | 82 | 93 | 94 |
| Shore D¹ | 46 | 18 | 29 | 35 | 39 |

¹after 1 week curing at room temperature.

### Example 2

The previously formed part A compositions were mixed with LOCTITE UK178B as described above and used to form hardness test specimens. All amounts are % by weight of that part. The samples were checked with a probe and subjectively evaluated for tackiness. Once the sample was non-tacky the Shore A hardness was checked. Test results are shown below.

| | A | 1 | 2 | 3 | 4 |
|---|---|---|---|---|---|
| 1 hour | very | tacky | nt¹ | very | very |
| | tacky | | | tacky | tacky |
| 2 hours | very | tacky | nt¹ | tacky | very |
| | tacky | | | | tacky |
| 3 hours | tacky | soft not | nt¹ | slightly | tacky |
| | | tacky | | tacky | |
| 4 hours | slightly | 9 | nt¹ | soft not | slightly |
| | tacky | | | tacky | tacky |
| 5 hours | 20 | 16 | nt¹ | 25 | 14 |

¹nt = not tested

### Example 3

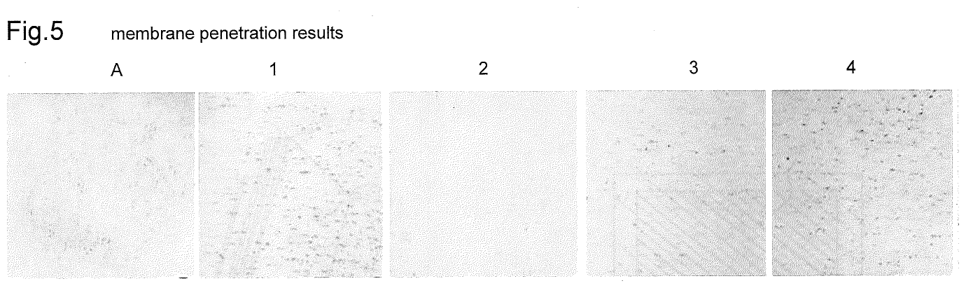

The previously formed part A compositions were mixed with LOCTITE UK178B as described above and tested for membrane penetration. Results are shown in the table below and in FIGS. 5 and 6.

| | A | 1 | 2 | 3 | 4 |
|---|---|---|---|---|---|
| part A | | | | | |
| castor oil (wt. %) | — | 95 | 93 | 92 | 91 |
| beeswax (wt. %) | — | 5 | 5 | 5 | 5 |
| glycerol (wt. %) | — | 0 | 2 | 3 | 4 |
| part B | | | | | |
| LOCTITE | 100 | 100 | 100 | 100 | 100 |
| UK178B | | | | | |
| penetration (%) | 0-5 | 0-5 | 0-5 | 0-5 | 0-5 |

### Example 4

The following compositions were formed into 1 mm cast films and cured. The cured films were cut into 1″ circles and weighed, then placed in glass jars containing deionized (DI) water at different pH levels; 1.5, neutral (7-8), and 12.5. The 1.5 pH solution was prepared by adding HCl to deionized water. The 12.5 pH solution was prepared by adding NaOH to deionized water. Samples were held in the solution at either 80° C. for 2 weeks or 50° C. for 4 weeks, with weight checks performed every week (samples are removed from jars, dried, and weighed, then placed back in jars for conditioning). Cured composition chemical resistance test results shown below are expressed as % weight loss (−) or gain (+) from unconditioned sample.

| | A | 1 | 2 | B | C |
|---|---|---|---|---|---|
| part A | | | | | |
| castor oil (wt. %) | — | 95 | 93 | 94 | 93 |
| beeswax (wt. %) | — | 5 | 5 | 5 | 5 |
| glycerol (wt. %) | — | 0 | 2 | — | — |
| triethanolamine | — | 0 | 0 | 1 | 0 |
| polyvinyl chloride | — | 0 | 0 | 0 | 2 |
| part B | | | | | |
| LOCTITE UK178B | 100 | 100 | 100 | 100 | 100 |
| pH 1.5, 80° C., | +0.49 | +0.2 | +0.53 | +0.66 | +0.49 |
| 3 weeks (%) | | | | | |
| pH 7.0, 80° C., | +0.51 | +0.08 | +0.42 | +1.09 | +0.98 |
| 3 weeks (%) | | | | | |
| pH 12.5, 80° C., | +0.54 | −0.26 | +1.38 | +1.08 | +0.62 |
| 3 weeks (%) | | | | | |
| pH 1.5, 50° C., | +0.50 | +0.25 | +0.16 | 0.26 | 0.09 |
| 4 weeks (%) | | | | | |
| pH 7.0, 50° C., | +0.39 | +0.30 | +0.26 | 0.20 | 0.24 |
| 4 weeks (%) | | | | | |
| pH 12.5, 50° C., | +0.44 | +0.31 | +0.28 | 0.34 | 0.38 |
| 4 weeks (%) | | | | | |

1 nt = not tested

For each temperature range a weight loss or gain of less than 2% is considered acceptable and a weight loss or gain of less than 1% is preferable. A weight loss or gain of 5% or more is considered unacceptable for many applications.
Comparative Samples B and C replaced glycerol with triethanolamine and polyvinyl chloride respectively. Both of comparative samples B and C had high dissolution of the cured material in the test media and therefore low chemical resistance.

### Example 5

Samples 2, E and F were prepared as described above and mixed with LOCTITE UK178B as described above. Samples 5 and D were prepared by heating the part A components to 55° C. and subjecting the heated mix to very high shear from a 2400 rpm mixer. samples 5 and D were mixed with LOCTITE UK178B as described above. All amounts are % by weight of that part. The samples were checked for properties. Test results are shown below.

| | 2 | 5 | D | E | F |
|---|---|---|---|---|---|
| part A | | | | | |
| castor oil | 93 | 93 | 95.5 | 0 | 0 |
| (wt. %) | | | | | |
| beeswax | 5 | 5 | 0 | 5 | 5 |
| (wt. %) | | | | | |
| glycerol | 2 | 2 | 2 | 2 | 2 |
| (wt. %) | | | | | |
| RheoBYK³ | 0 | 0 | 2.5 | 0 | 0 |
| mineral | 0 | 0 | 0 | 93 | 0 |
| oil gel | | | | | |
| Canola oil | 0 | 0 | 0 | 0 | 93 |
| viscosity | 44,000 | 141,500 | 136,000 | 48,500 | 29,000 |
| 2 rpm | | | | | |
| viscosity | 13,200 | 19,750 | 20,900 | 11,100 | 4,950 |
| 20 rpm | | | | | |
| thixotropic | 7.2 | 6.5 | 3.3 | 4.37 | 5.86 |
| index | | | | | |
| part B | | | | | |
| LOCTITE | 100 | 100 | 100 | 100 | 100 |
| UK178B | | | | | |
| mixed | | | | | |
| composition | | | | | |
| viscosity | 12,000 | 9,500 | 31,500 | 29,000 | 9,000 |
| 2 rpm | | | | | |
| viscosity | 10,200 | 7,800 | 11,950 | 14,500 | 2,250 |
| 20 rpm | | | | | |
| open time | 30 | 28 | 38 | 140 | 140 |
| (min) | | | | | |
| gel time | 36 | 34 | 44 | nt¹ | nt¹ |
| (min) | | | | | |
| Shore A² | 66 | 64 | 64 | 0 | 1 |
| Shore D² | 19 | 17 | 20 | 0 | 0 |

¹not tested
²after 1 week curing at room temperature.
³available from BYK

The preparation method of samples 5 and D resulted in a much higher viscosity for the part A as compared to the other samples. In comparative Sample E there were particles of reacted beeswax and isocyanate from the LOCTITE UK178B, however after 24 hours of mixing this part A and part B the mineral oil had not reacted and the sample was still a fluid at room temperature. In comparative sample F the beeswax and isocyanate from the LOCTITE UK178B reacted to form a somewhat gelled or solid top layer over a fluid bottom layer. The top layer was not solid enough to obtain a Shore A hardness reading. Neither sample E nor Sample F had an acceptable open time or gel time. Samples 2 and 5 illustrate beeswax in this composition provides a sustainable alternative to Rheocin. The samples show beeswax is an effective reactive thickener when combined with castor oil.

Samples 2 and 5 had a shorter and more desirable open time and gel time compared to Sample D made using the commercially available RheoBYK thixotrope. Beeswax is a surprisingly good thixotrope as well as being sustainably sourced.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

1. A two-part curable polyurethane adhesive composition, including:
part A comprising an isocyanate reactive component; a sustainable reactive rheology modifier, glycerol and optionally additives; and
part B comprising a polyisocyanate and optionally additives;
wherein the polyurethane adhesive composition comprises at least 60 wt. % sustainable materials by weight of the composition.

2. The two-part curable polyurethane adhesive composition of claim 1, wherein part B comprises an isocyanate functional polyurethane prepolymer that is the reaction product of MDI or modified MDI and an isocyanate reactive component.

3. The two-part curable polyurethane adhesive composition of claim 1, wherein the part A isocyanate reactive component is 95-100% sustainable.

4. The two-part curable polyurethane adhesive composition of claim 1, wherein the part A isocyanate reactive component comprises a sustainable plant oil having 2 to 4 hydroxyl groups.

5. The two-part curable polyurethane adhesive composition of claim 1, wherein the reactive rheology modifier comprises natural beeswax.

6. A separation apparatus comprising:
a membrane capable of separating a first constituent from a feed fluid mixture comprising the first constituent and a second constituent; and
a mixed, two component polyurethane adhesive disposed in one or more discrete areas on the membrane, wherein the two-component polyurethane adhesive comprises:
part A comprising an isocyanate reactive component; a sustainable reactive rheology modifier, glycerol and optionally additives; and
part B comprising a polyisocyanate and optionally additives;
wherein the polyurethane adhesive composition comprises at least 60 wt. % sustainable materials by weight of the composition and the mixed, two component polyurethane adhesive has a percent penetration into the membrane layer prior to curing.

7. The separation apparatus according to claim 6, wherein the percent penetration of the membrane layer by the polyurethane adhesive is at least 5%.

8. The separation apparatus according to claim 6, wherein the percent penetration of the membrane layer by the polyurethane adhesive is at least 50%.

9. The separation apparatus according to claim 6, wherein the percent penetration of the membrane layer by the polyurethane adhesive is at least 80%.

10. The separation apparatus according to claim 6, wherein the separation apparatus further comprises a feed carrier material.

11. The separation apparatus according to claim 6, wherein the separation apparatus further comprises a porous permeate carrier layer which is bonded with the two-component polyurethane adhesive.

12. The separation apparatus according to claim 6, wherein the part A has a viscosity of less than 100,000 cPs at 25° C.

13. The separation apparatus according to claim 6, wherein the viscosity of part A at 25° C. is less than 30,000 cPs, measured on a Brookfield viscometer at 20 RPM and spindle 6.

14. The separation apparatus according to claim 6, wherein the component A and the component B are present in a stoichiometric ratio of 0.95:1 to 1.40:1 based on the number of moles of isocyanate groups in part B and the number of moles of isocyanate-reactive groups in part A.

15. The separation apparatus according to claim 6, wherein part A comprises 50 wt. % to 95 wt. % castor oil as the isocyanate reactive component and 0.5 wt. % to 20 wt. % beeswax as the sustainable reactive rheology modifier.

16. The separation apparatus according to claim 6, wherein the polyisocyanate comprises methylene diphenyl diisocyanate.

17. (canceled)

18. (canceled)

19. The separation apparatus according to claim 6, wherein the separation apparatus is spiral wound membrane filter.

20. The separation apparatus according to claim 6, wherein the membrane comprises at least two layers.

21. The separation apparatus according to claim 6, wherein the membrane comprises a polyamide layer and a polysulfone layer.
